(19) United States
(12) Patent Application Publication
(10) Pub. No.: US 2007/0083661 A1
(43) Pub. Date: Apr. 12, 2007

(54) Session control method and terminal for PoC

(75) Inventor: Fei Lin, Shenzhen (CN)

Correspondence Address: MERCHANT & GOULD PC, P.O. BOX 2903, MINNEAPOLIS, MN, 55402-0903, US

(73) Assignee: Huawei Technologies Co., Ltd., Shenzhen (CN)

(21) Appl. No.: 11/545,949

(22) Filed: Oct. 10, 2006

(30) Foreign Application Priority Data
Oct. 11, 2005 (CN) 200510030400.8

(51) Int. Cl. G06F 15/16

(52) U.S. Cl. 709/227

(57) ABSTRACT

The present invention discloses a session control method and terminal for PoC. The method includes the following steps: an originating client receiving an instruction from a user, creating and sending a session initiation request or a request for rejoining the session to a server, and entering into a creating state; if the client in the creating state receives a successful response from the server, it entering into a created state; if the client in the created state receives a notification of leaving the session from the server, it ending the session. The present invention provides a practical solution for processing a PoC session creation and a good control means for synchronously initiated PoC sessions.

### FIELD OF THE INVENTION

The present invention relates to session control technology in communication fields, and more particularly to a session control method and terminal for PoC (Push To Talk over Cellular).

### BACKGROUND OF THE INVENTION

PoC is also called wireless push-to-talk. It introduces direct point-to-point and point-to-points voice communication service in the cellular network. It enables the user to enjoy the popular bi-directional wireless talk service with a mobile phone and helps to promote the mobile services. The PoC service improves the network utilization efficiency of the mobile operator, and greatly increases the data service throughput. Therefore it is exploring new opportunities for the mobile operators and the service providers.

Generally speaking, the PoC service has the characteristics of voice over IP (VoIP) communication service and instant short message service, such as the online state indication, messages and etc. The user may enjoy the voice services such as the one-to-one session, special group, group session and chat group.

Currently, the Open Mobile Alliance (OMA) is working on the standardization of the PoC. The PoC solution of OMA is based on the Session Initiation Protocol (SIP) and the RealTime Transfer Protocol (RTP) defined by the Internet Engineering Task Force (IETF).

Specifically, the SIP is used as a control plane for the PoC protocol and provides the following functions:

1. Registering and authenticating the user in the network;

2. Defining, creating and managing the session process;

3. Supporting the display of other users' online state;

4. Sending alarms (messages) between users.

It can be seen from above that the session control interface related to the PoC client, i.e. PoCl, adopts the SIP protocol. Since the resource is limited, the application layer protocols usually perform transmission based on the IP/UDP.

However, in this mode, the SIP message between the PoC client and the PoC server is usually an asynchronous message.

For this kind of asynchronous message mechanism, there is no mature solution to process the creation of the PoC session correctly, especially to control the conference state of the PoC clients.

### SUMMARY OF THE INVENTION

The present invention provides a session control method for PoC, which includes the steps of:
an originating client receiving an instruction from a user, creating and sending a session initiation request or a request for rejoining the session to a server, and entering into a creating state;
if the client in the creating state receives a successful response from the server, it entering into a created state;
if the client in the created state receives a notification of leaving the session from the server, it ending the session.

Preferably, the originating client further implements a session instance creation process after receiving the instruction from the user.

Preferably, the session control method for PoC further includes the steps of:
if the client in the created state receives an instruction of initiatively leaving the session from the user, it sending a request for leaving the session to the server and entering into a releasing state;
if the client in the releasing state receives a response for leaving the session from the server, it ending the session.

Preferably, the session control method for PoC further includes the steps of:
if the client in the creating state receives a notification of leaving the session or a failure response from the server, it ending the session.

Preferably, the session control method for PoC further includes the steps of:
if the client in the creating state receives an instruction of canceling the session initiation from the user, it entering into a canceling state;
if the client in the canceling state receives a successful response from the server, it sending a request for ending the session to the sever and ending the session;
if the client in the canceling state receives a failure response from the server, it ending the session;
if the client in the canceling state receives a ringing message from the server, it sending a request for cancelling the session to the server and ending the session.

Preferably, the session control method for PoC further includes the steps of:
if the client in the creating state receives a ringing response from the server, it entering into the ringing state;
if the client in the ringing state receives a successful response from the server, it entering into the created state;
if the client in the ringing state receives a failure response from the server or a request for canceling the session from the user, it ending the session.

Preferably, the client is in the initial state in the procedure from creating the session instance to sending the session initiation request or the request for rejoining the session to the server.

In order to achieve the above object, the present invention also provides a session control method for PoC, including the steps of:
a terminating client entering into a creating state, if the client is in an automatic answering state, after receiving a session invitation notification from a server;
if the client in the creating state receives an acknowledgement for the session invitation from the server, it entering into a created state;
if the client in the created state receives a notification of leaving the session from the server, it ending the session.

Preferably, the session control method for PoC further includes the steps of:
the client entering into a ringing state, if the client is in a manual answering state, when receiving the session invitation notification from a server;
if the client in the ringing state receives an instruction of accepting the session invitation from the user, it entering into the creating state;
if the client in the ringing state receives an instruction of refusing the session invitation from the user, it ending the session.

Preferably, the terminating client further implements a session instance creation process after receiving the session invitation notification from the server.

Preferably, the session control method for PoC further includes the steps of:
if the client in the created state receives an instruction of initiatively leaving the session from the user, it sending a request for leaving the session to the server and entering into the releasing state;
if the client in the releasing state receives a response for leaving the session from the server, it ending the session.

Preferably, the client is in the initial state before it is in the creating state or the ringing state.

The present invention provides a session control originating terminal for PoC, which is connected to a server. The originating terminal includes a creating and sending unit and a control unit. The creating and sending unit is configured to create a session initiation request or a request for rejoining the session and send it to the server upon receiving an instruction from a user; and the control unit is configured to control the session. Based on the creation and transmission of a session initiation request or a request for rejoining the session, the control unit controls the originating terminal to enter into a creating state; if the control unit receives a successful response from the server when the originating client is in the creating state, the control unit controls the PoC originating client to enter into a created state; and if the control unit receives a notification of leaving the session from the server when the originating client is in the created state, the control unit ends the session.

The present invention provides a session control terminating terminal for PoC, which is connected to a server. The terminating terminal includes a receiving unit and a control unit. The receiving unit is configured to receive a message from the server; and the control unit is configured to control the session. When the terminating terminal is in an automatic answering state and the receiving unit receives a session invitation notification from a server, the control unit controls the terminating terminal to enter into a creating state; if the receiving unit receives an acknowledgement for the session invitation from the server when the terminating terminal is in the creating state, the control unit controls the terminating terminal to enter into a created state; and if the receiving unit receives a notification of leaving the session from the server when the terminating terminal is in the created state, the control unit ends the session.

It can be seen from the above comparison that the main difference between the present invention and the prior art is that the present invention adopts the state machine to realize the conference state switch for the PoC originating client and the terminating client, and the present invention defines a plurality of states and the conditions for the switch between these states in conjunction with the events related to the states in the PoC session. The present invention provides a practical solution for processing a PoC session creation and a good control means for synchronously initiated PoC sessions.

### BRIEF DESCRIPTION OF THE DRAWINGS

FIG. 1 is a schematic diagram showing the state machine of an originating client according to an embodiment of the present invention;

FIG. 2 is a schematic diagram showing the state machine of a terminating client according to another embodiment of the present invention.

### DETAILED DESCRIPTION OF THE INVENTION

The present invention will be illustrated in detail with reference to the drawings and embodiments in order to make the solution and advantages of the present invention more apparent.

The principle of PoC is described briefly as follows: to start a conversation, all the user needs is to push a button. Through “always online” connection, the user only needs to press a key on the phone to initiate a personal call or group call. The call is instantly connected and the receiver doesn't need to answer the call intentionally. The user of the PoC voice service is usually dealing with other business when receiving an incoming call, and he may listen to the group session while continuing his work on hand. A user may join the group session by using his name and occasionally express his opinions to the group. Half duplex session is especially suitable for this type of occasion.

In addition, the users may form a session group on the basis of “special setting” and don't need to access their service providers, which facilitates initiative and flexible group sessions. This kind of simple and direct communication meets the diversified demands of both business users and individual users, ranging from the controlled team management to spontaneous sharing of experience and pleasure. The PoC voice service is a real differentiated voice service, because it is not a replacement of any cellular service. The PoC service enables the operator to develop new voice services without changing the traditional voice services.

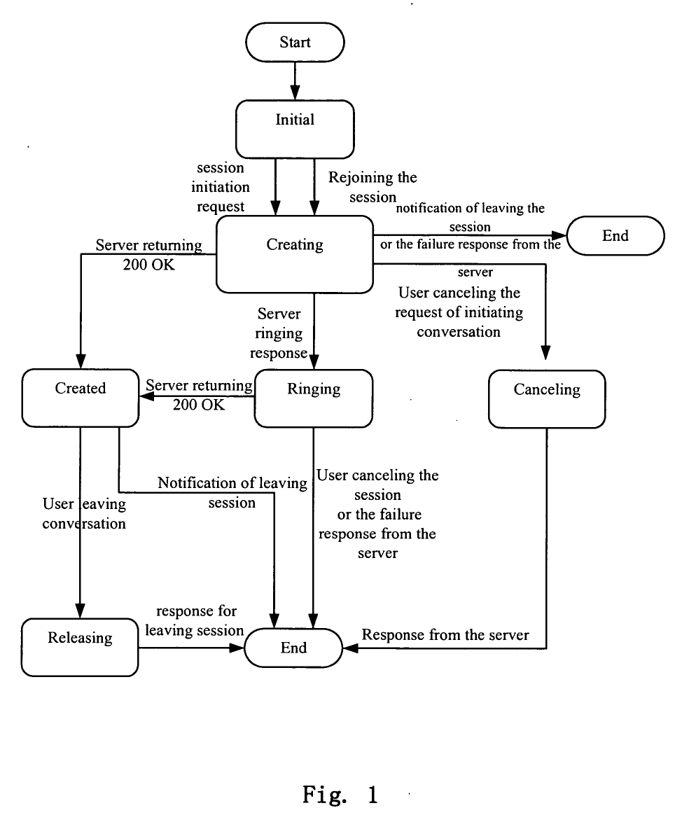

FIG. 1 is a schematic diagram showing the state machine of a PoC originating client according to an embodiment of the present invention. The state machine includes the initial state, creating state, created state, releasing state, ringing state and canceling state, and they will be described in detail as follows:

Initial state:

The conference of the PoC client enters into the initial state after receiving an instruction from the PoC user. The initial state means the client is performing the initialization, such as creating session instance and etc. Here are the two cases:

One is that the PoC client creates a SIP initial session request and sends it to the server after receiving an instruction for initiating a session (including the predefined group session, temporary group session, chat group session) from the PoC user, and then the conference of the PoC client enters into the creating state.

The other is that the PoC client creates a SIP initial session request and sends it to the server after receiving an instruction of rejoining the session from the PoC user, and then the conference of the PoC client enters into the creating state. The PoC user may rejoin the session rejected or left before.

Creating state:

In the case of creating state, the user is in a waiting state, and when receiving a message from the server or the further instruction from the user, the user enters into a corresponding state.

When the client is in the creating state, if it receives a 200 OK message (indicating the session is created successfully) returned from the server, the conference of the PoC client enters into the created state.

When the client is in the creating state, if it receives a failure response or a notification of leaving the session returned from the server, the client ends the process of the session invitation and presents the session failure information to the user.

When the client is in the creating state, if it receives a ringing response from the server, the conference of the PoC client enters into the ringing state.

When the client is in the creating state, if it receives an instruction of canceling the session initiation from the user, the client sends a request of canceling the session initiation and enters into the canceling state.

Created state:

In the case of created state the session is already created, and the created state is a comparatively stable state of the PoC session. In the created state, many operations, such as suspending or recovering a session, inviting a user to join the session and eliminating a PoC participant from the session, may be implemented. There are two modes of leaving the session in this state: one is that the user initiatively leaves the session, and the other is that the user passively leaves the session in response to the notification from the server.

When the client is in the created state, if it receives an instruction of initiatively leaving the session from the user, the client creates a SIP BYE request message and sends the message to the server, and then the conference of the client enters into the releasing state.

When the client is in the created state, if it receives the BYE notification from the server, the client ends the session.

Releasing state:

In the releasing state, the client has already sent the BYE request to the server and is waiting for the response from the server. If the client doesn't receive the response from the server in predetermined time, it will resend the BYE request to the server.

When the client is in the releasing state, if it receives a response from the server for the BYE request, the client ends the session.

Ringing state

In the case of ringing state, the client may hear the ringing tone and is waiting for the other called party to join the session. One typical case is that the called party manually answers the session request, and the called terminal continues ringing until the called party agrees to join the session or the calling party cancels the session request.

When the client is in the ringing state, if it receives a 200 OK message (indicating the session is created successfully) returned from the server, the conference of the client enters into the created state.

When the client is in the ringing state, if it receives a failure response from the server, the client ends the session invitation process and presents the session failure information to the user.

When the client is in the ringing state, if it receives an instruction of canceling the session from the user, the client ends the session invitation process.

Canceling state:

In the case of canceling state, the client has sent a request of canceling the session initiation to the server and is waiting for the response from the server. If the client doesn't receive a response from the server in predetermined time, it will resend the request of canceling the session initiation to the server.

When the client is in the canceling state, if it receives a 200 OK (successful response) message from the server, the client sends a BYE message to the server and ends the session invitation process.

When the client is in the canceling state, if it receives a ringing response (180 Ringing or 183 Session Progress) from the server, the client sends a cancel message to the server and ends the session invitation process.

When the client is in the canceling state, if it receives a failure response from the server, the client ends the session invitation process and presents the session failure information to the user.

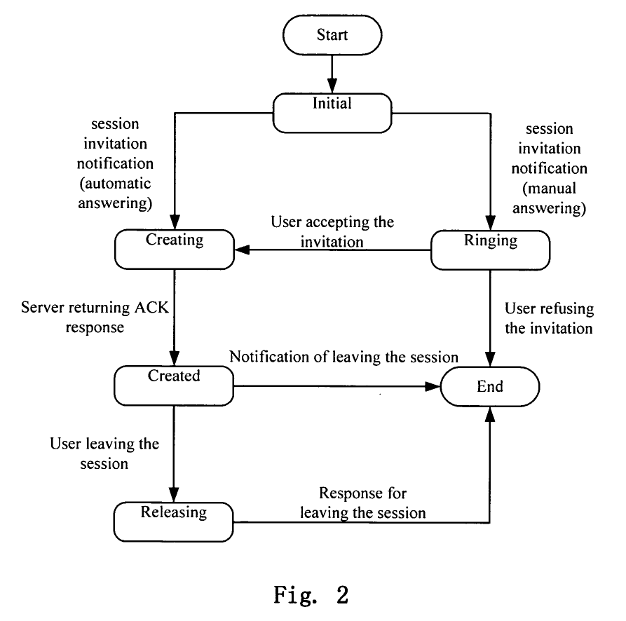

FIG. 2 is a schematic diagram showing the state machine of a PoC terminating client according to another embodiment of the present invention. The state machine includes the initial state, creating state, created state, releasing state and ringing state, and they will be described in detail as follows:

Initial state:

The client enters into the initial state after receiving a session invitation from the server. The initial state means the client is performing the initialization including a session instance creation and etc.

When the client is in the initial state, if the answering mode for this session is the automatic answering, the conference of the client enters into the creating state.

When the client is in the initial state, if the answering mode for this session is the manual answering, the conference of the client enters into the ringing state.

Creating state:

In the case of creating state, the client is waiting for the server to finish the session creation process.

When the client is in the creating state, if it receives an ACK response from the server for the session invitation, the conference of the client enters into the created state.

Created state:

In the case of created state the session is already created, and this state is a comparatively stable state of the PoC session. In the created state, many operations, such as suspending or recovering a session, inviting a user to join the session and eliminating a PoC participant from the session, may be implemented. There are two modes of leaving the session in this state: one is that the user initiatively leaves the session, and the other is that the user passively leaves the session in response to the notification from the server.

When the client is in the created state, if it receives an instruction of initiatively leaving the session from the user, the client creates a SIP BYE request message and sends the message to the server, and then the conference of the client enters into the releasing state.

When the client is in the created state, if it receives the BYE notification from the server, the client ends the session.

Releasing state:

In the releasing state, the client has already sent the BYE request to the server and is waiting for the response from the server. If the client doesn't receive the response from the server in predetermined time, it will resend the BYE request to the server.

When the client is in the releasing state, if it receives a response from the server for the BYE request, the client ends the session.

Ringing state:

In the case of ringing state, the client is ringing and indicates the user someone is calling.

When the client is in the ringing state, if it receives an instruction indicative of acceptance (the user accepts the session invitation) from the PoC terminal user, the conference of the PoC client enters into the creating state.

When the client is in the ringing state, if it receives an instruction of refusing (the user refuses the session invitation) from the PoC terminal user, the client ends the session invitation process.

According to the state machine of a PoC originating client and that of a PoC terminating client, the present invention may also propose a PoC originating client and a PoC terminating client.

The PoC originating client may include a creating and sending unit and a control unit. Upon receiving an instruction from a user, the creating and sending unit creates a session initiation request or a request for rejoining the session and sends it to a server. Based on the creation and transmission of a session initiation request or a request for rejoining the session, the control unit controls the PoC originating client to enter into a creating state. Then, if the control unit receives a successful response from the server when the originating client is in the creating state, the control unit controls the PoC originating client to enter into a created state. Moreover, if the control unit receives a notification of leaving the session from the server when the originating client is in the created state, the control unit ends the session.

During the session control procedure, upon receiving the instruction from the user, the control unit of the terminating client also creates a session instance.

If the client is in the created state receives an instruction of initiatively leaving the session from the user, the creating and sending unit sends a request for leaving the session to the server and control unit of the client controls the client to enter into a releasing state; and if the client is in the releasing state receives a response for leaving the session from the server, the control unit of the client ends the session.

If the client is in the creating state receives a notification of leaving the session or a failure response from the server, the control unit of the client ends the session.

If the client is in the creating state receives an instruction of canceling the session initiation from the user, the control unit of the client controls the client to enter into a canceling state.

If the client is in the canceling state receives a successful response from the server, the creating and sending unit sends a request for ending the session to the sever and the control unit of the originating client ends the session; if the client is in the canceling state receives a failure response from the server, the control unit ends the session; and if the client is in the canceling state receives a ringing message from the server, the creating and sending unit sends a request for cancelling the session to the server and the control unit ends the session.

if the client is in the creating state receives a ringing response from the server, the control unit controls the originating client to enter into a ringing state; if the client is in the ringing state receives a successful response from the server, the control unit controls the originating client to enter into a created state; and if the client is in the ringing state receives a failure response from the server or a request for canceling the session from the user, the control unit ends the session.

It is to be noted that the client is in the initial state in the procedure from creating the session instance to sending the session initiation request or the request for rejoining the session to the server.

The PoC terminating client may include a receiving unit and a control unit. When the terminating client is in an automatic answering state and the receiving unit receives a session invitation notification from a server, the control unit controls the terminating client to enter into a creating state. If the receiving unit receives an acknowledgement for the session invitation from the server when the terminating client is in the creating state, the control unit controls the terminating client to enter into a created state. Moreover, if the receiving unit receives a notification of leaving the session from the server when the terminating client is in the created state, the control unit ends the session. During the session control procedure, if the client is in a manual answering state when the receiving unit receives the session invitation notification from a server, the control unit of the terminating client controls the terminating client to enter into a ringing state; and if the client is in the ringing state when the receiving unit receives an instruction of accepting the session invitation from the user, the control unit controls the terminating client to enter into the creating state.

If the client is in the ringing state when the receiving unit receives an instruction of refusing the session invitation from the user, the control unit of the terminating client ends the session.

if the client is in the created state when the receiving unit receives an instruction of initiatively leaving the session from the user, the control unit of the terminating client sends a request for leaving the session to the server and controls the terminating client to enter into the releasing state; and if the client is in the releasing state when the receiving unit receives a response for leaving the session from the server, the control unit of the terminating client ends the session.

It is to be noted that the terminating client is in the initial state before it is in the creating state or the ringing state and the terminating client further implements a session instance creation process after receiving the session invitation notification from the server.

The above embodiments are only some typical applications of the present invention and the states of the state machine may be increased or reduced according to the practical requirements.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

1. A session control method for PoC, comprising the steps of:
upon receiving an instruction from a user, creating and sending, by an originating client, a session initiation request or a request for rejoining the session to a server, and entering into a creating state;
entering into a created state, if the originating client in the creating state receives a successful response from the server;
ending the session, if the originating client in the created state receives a notification of leaving the session from the server.

2. The session control method for PoC according to claim 1, the method further comprising:
upon receiving the instruction from the user, creating, by the originating client, a session instance.

3. The session control method for PoC according to claim 1, further comprising the steps of:
sending, by the client, a request for leaving the session to the server and entering into a releasing state, if the client in the created state receives an instruction of initiatively leaving the session from the user;
ending, by the client, the session, if the client in the releasing state receives a response for leaving the session from the server.

4. The session control method for PoC according to claim 1, further comprising the step of:
ending, by the client, the session, if the client in the creating state receives a notification of leaving the session or a failure response from the server.

5. The session control method for PoC according to claim 4, further comprising the step of:
entering into a canceling state, if the client in the creating state receives an instruction of canceling the session initiation from the user.

6. The session control method for PoC according to claim 5, further comprising the steps of:
sending, by the client, a request for ending the session to the sever and ending, by the client, the session, if the client in the canceling state receives a successful response from the server;
ending, by the client, the session, if the client in the canceling state receives a failure response from the server;
sending, by the client, a request for cancelling the session to the server and ending, by the client, the session, if the client in the canceling state receives a ringing message from the server.

7. The session control method for PoC according to claim 1, further comprising the steps of:
entering into a ringing state, if the client in the creating state receives a ringing response from the server;
entering into a created state, if the client in the ringing state receives a successful response from the server;
ending, by the client, the session, if the client in the ringing state receives a failure response from the server or a request for canceling the session from the user.

8. The session control method for PoC according to claim 2, wherein the client is in the initial state in the procedure from creating the session instance to sending the session initiation request or the request for rejoining the session to the server.

9. A session control method for PoC, comprising the steps of:
entering into a creating state, if a terminating client is in an automatic answering state after receiving a session invitation notification from a server;
entering into a created state, if the client in the creating state receives an acknowledgement for the session invitation from the server;
ending, by the client, the session, if the client in the created state receives a notification of leaving the session from the server.

10. The session control method for PoC according to claim 9, further comprising the steps of:
entering into a ringing state, if the client is in a manual answering state when receiving the session invitation notification from a server;
entering into the creating state, if the client in the ringing state receives an instruction of accepting the session invitation from the user;
ending, by the client, the session, if the client in the ringing state receives an instruction of refusing the session invitation from the user.

11. The session control method for PoC according to claim 9, wherein the terminating client further implements a session instance creation process after receiving the session invitation notification from the server.

12. The session control method for PoC according to claim 9, further comprising the steps of:
sending, by the client, a request for leaving the session to the server and entering into a releasing state, if the client in the created state receives an instruction of initiatively leaving the session from the user;
ending, by the client, the session, if the client in the releasing state receives a response for leaving the session from the server.

13. The session control method for PoC according to claim 12, wherein the client is in the initial state before it is in the creating state or the ringing state.

14. A session control originating terminal for PoC, which is connected to a server, comprising:
a creating and sending unit configured to create a session initiation request or a request for rejoining the session and send it to the server upon receiving an instruction from a user;
a control unit configured to control the session, wherein
based on the creation and transmission of a session initiation request or a request for rejoining the session, the control unit controls the originating terminal to enter into a creating state,
if the control unit receives a successful response from the server when the originating client is in the creating state, the control unit controls the PoC originating client to enter into a created state,
if the control unit receives a notification of leaving the session from the server when the originating client is in the created state, the control unit ends the session.

15. The session control originating terminal for PoC according to claim 14, wherein
if the originating terminal in the created state receives an instruction of initiatively leaving the session from the user, the creating and sending unit sends a request for leaving the session to the server and the control unit controls the originating terminal to enter into a releasing state;
if the originating terminal in the releasing state receives a response for leaving the session from the server, the control unit ends the session.

16. The session control originating terminal for PoC according to claim 14, wherein
if the originating terminal in the creating state receives a notification of leaving the session or a failure response from the server, the control unit ends the session.

17. The session control originating terminal for PoC according to claim 16, wherein
if the originating terminal in the creating state receives an instruction of canceling the session initiation from the user, the control unit controls the originating terminal to enter into a canceling state.

18. The session control originating terminal for PoC according to claim 17, wherein
if the originating terminal in the canceling state receives a successful response from the server, the creating and sending unit sends a request for ending the session to the sever and the control unit ends the session;
if the originating terminal in the canceling state receives a failure response from the server, the control unit ends the session;
if the originating terminal in the canceling state receives a ringing message from the server, the creating and sending unit sends a request for cancelling the session to the server and the control unit ends the session.

19. The session control originating terminal for PoC according to claim 14, wherein
if the originating terminal in the creating state receives a ringing response from the server, the control unit controls the originating terminal to enter into a ringing state;
if the originating terminal in the ringing state receives a successful response from the server, the control unit controls the originating terminal to enter into a created state;
if the originating terminal in the ringing state receives a failure response from the server or a request for canceling the session from the user, the control unit ends the session.

20. A session control terminating terminal for PoC, which is connected to a server, comprising:
a receiving unit configured to receive a message from the server;
a control unit configured to control the session, wherein
when the terminating terminal is in an automatic answering state and the receiving unit receives a session invitation notification from a server, the control unit controls the terminating terminal to enter into a creating state,
if the receiving unit receives an acknowledgement for the session invitation from the server when the terminating terminal is in the creating state, the control unit controls the terminating terminal to enter into a created state,
if the receiving unit receives a notification of leaving the session from the server when the terminating terminal is in the created state, the control unit ends the session.

21. The session control terminating terminal for PoC according to claim 20, wherein
if the terminating terminal is in a manual answering state when the receiving unit receives the session invitation notification from a server, the control unit controls the terminating terminal to enter into a ringing state;
if the terminating terminal is in the ringing state when the receiving unit receives an instruction of accepting the session invitation from the user, the control unit controls the terminating terminal to enter into the creating state;
if the terminating terminal is in the ringing state when the receiving unit receives an instruction of refusing the session invitation from the user, the control unit ends the session.

22. The session control terminating terminal for PoC according to claim 20, wherein
if the terminating terminal is in the created state when the receiving unit receives an instruction of initiatively leaving the session from the user, the control unit sends a request for leaving the session to the server and controls the terminating terminal to enter into a releasing state;
if the terminating terminal is in the releasing state when the receiving unit receives a response for leaving the session from the server, the control unit ends the session.
